(19) United States
(12) Patent Application Publication
(10) Pub. No.: US 2026/0086073 A1
(43) Pub. Date: Mar. 26, 2026

(54) INTEGRATED ELUENT GENERATOR AND CONTINUOUSLY REGENERATED TRAP COLUMN CARTRIDGE

(71) Applicant: Dionex Corporation, Sunnyvale, CA (US)

(72) Inventors: Yongjing CHEN, Santa Clara, CA (US); Yan LIU, Palo Alto, CA (US)

(21) Appl. No.: 18/895,994

(22) Filed: Sep. 25, 2024

(51) Int. Cl. G01N 30/96

(52) U.S. Cl. CPC G01N 30/96; G01N 2030/965

(57) ABSTRACT

An electrolytic device for an ion chromatography system includes a first electrolyte reservoir including a first electrolyte solution and a first electrode; an eluent generation chamber including a second electrode; and a first ion exchange connector coupling the eluent generation chamber to the first electrolyte reservoir. The first ion exchange connector including one or more first ion exchange membranes allowing passage of counter ions with a first charge but excluding ions with an opposite charge. The electrolytic device further includes a second electrolyte reservoir including a second electrolyte solution and a third electrode; a trap chamber including a fourth electrode; and a second ion exchange connector coupling the trap chamber to the second electrolyte reservoir. The second ion exchange connector including one or more second ion exchange membranes. The second ion exchange membranes excluding ions of the first charge but allowing passage of contaminant ions of the opposite charge.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### FIELD OF THE INVENTION

The present disclosure generally relates to the field of ion chromatography including integrated eluent generator and continuously regenerated trap column cartridge.

### BACKGROUND OF THE INVENTION

Ion chromatography (IC) is a widely used analytical technique for the determination of anionic and cationic analytes in various sample matrices. Conductivity detectors are often used in IC to detect anionic and cationic analytes.

In reagent-free ion chromatography (RFIC), the system can automatically generate high purity hydroxide, carbonate, bicarbonate, or methanesulfonic acid (MSA) and other acidic, basic, and salt eluents electrolytically using an electrolytic eluent generator. The generated eluent can then be purified using a continuously regenerated trap column. RFIC systems also can include degassers and suppressors in addition to the separation column and detectors. There is a need to reduce the complexity of RFIC systems.

### SUMMARY OF THE INVENTION

In a first aspect, an electrolytic device for an ion chromatography system can include a first electrolyte reservoir including a first electrolyte solution and a first electrode; an eluent generation chamber including a second electrode; a first ion exchange connector coupling the eluent generation chamber to the first electrolyte reservoir, the first ion exchange connector including one or more first ion exchange membranes allowing passage of counter ions with a first charge but excluding ions with an opposite charge; a second electrolyte reservoir including a second electrolyte solution and a third electrode; a trap chamber including a fourth electrode; and a second ion exchange connector coupling the trap chamber to the second electrolyte reservoir, the second ion exchange connector including one or more second ion exchange membranes, the second ion exchange membranes excluding ions of the first charge but allowing passage of contaminant ions of the opposite charge. The first and third electrodes can be connected to a current source and the second and fourth electrodes are connected to a common ground. The device can be configured to generate an eluent for chromatographic separation of ions of a second charge and to remove contaminant ions of the second charge from the eluent.

In various embodiments of the first aspect, the second and fourth electrodes can be porous electrodes. In particular embodiments, the first, second, third, and fourth electrodes are platinum electrodes.

In various embodiments of the first aspect, the concentration of the first electrolyte solution can be different than the concentration of the second electrolyte solution.

In various embodiments of the first aspect, the first ion exchange membranes can be anion exchange membranes, and the second ion exchange membranes can be cation exchange membranes. In particular embodiments, the first and third electrodes can be cathodes and the second and fourth electrodes can be anodes. In particular embodiments, the electrolyte can contain counter ions with a negative charge, the contaminant ions can be cations, and the chromatographic separation of ions can separate cations. In particular embodiments, the second electrolyte solution can include an anionic surfactant. In particular embodiments, the first electrolyte solution can include a cationic surfactant.

In various embodiments of the first aspect, the first ion exchange membranes can be cation exchange membranes, and the second ion exchange membranes can be anion exchange membranes. In particular embodiments, the first and third electrodes can be anodes and the second and fourth electrodes can be cathodes. In particular embodiments, the electrolyte can contain counter ions with a positive charge, the contaminant ions can be anions, and the chromatographic separation of ions can separate anions. In particular embodiments, the second electrolyte solution can include a cationic surfactant. In particular embodiments, the first electrolyte solution can include an anionic surfactant.

In various embodiments of the first aspect, the first ion exchange connector further can include one or more first reinforced ion exchange membranes, the first ion exchange membranes and the first reinforced ion exchange membranes can be stacked together. In particular embodiments, the first reinforced ion exchange membranes can include an ion exchange material bound to a polymer mesh.

In various embodiments of the first aspect, the first electrolyte solution or the second electrolyte solution can include a non-ionic surfactant.

In various embodiments of the first aspect, the trap chamber can be packed with a cation exchange resin material or an anion exchange resin material or a mixture of anion and cation exchange resin materials.

In a second aspect, a method of performing an ion chromatography separation can include flowing a solvent into an eluent generation chamber, the eluent generation chamber connected to a first electrolyte reservoir with a first ion exchange connector, the first electrolyte reservoir including a first electrolyte solution and a first electrode, the eluent generation chamber including a second electrode, the first electrode connected to a first current supply and the second electrode connected to a common ground; supplying a current from the first current supply to electrolyze the solvent at the second electrode and to drive eluent counter ions from the electrolyte reservoir through the first ion exchange connector into the solvent to generate an eluent; flowing the eluent into a trap chamber, the trap chamber connected to a second electrolyte reservoir with a second ion exchange connector, the second electrolyte reservoir chamber including a second electrolyte solution and a third electrode, the trap chamber including a fourth electrode, the third electrode connected to a second current supply and the fourth electrode connected to the common ground; supplying a current from the second current supply to drive contaminant ions from the trap chamber through the second ion exchange connector into the second electrolyte reservoir; and using the eluent to chromatographical separate ions within a sample.

In various embodiments of the second aspect, the second and fourth electrodes can be porous electrodes. In particular embodiments, the first, second, third, and fourth electrodes can be platinum electrodes.

In various embodiments of the second aspect, the concentration of the first electrolyte solution can be different than the concentration of the second electrolyte solution.

In various embodiments of the second aspect, the first ion exchange connector can include one or more first ion exchange membranes, the second ion exchange connector can include one or more second ion exchange membranes, the first ion exchange membranes can be anion exchange membranes, and the second ion exchange membranes can be cation exchange membranes. In particular embodiments, the first and third electrodes can be cathodes and the second and fourth electrodes can be anodes. In particular embodiments, the electrolyte can contain counter ions with a negative charge, the contaminant ions can be cations, and the chromatographic separation of ions can separate cations.

In various embodiments of the second aspect, the first ion exchange connector can include one or more first ion exchange membranes, the second ion exchange connector can include one or more second ion exchange membranes, the first ion exchange membranes can be cation exchange membranes, and the second ion exchange membranes can be anion exchange membranes. In particular embodiments, the first and third electrodes can be anodes and the second and fourth electrodes can be cathodes. In particular embodiments, the electrolyte can contain counter ions with a positive charge, the contaminant ions can be anions, and the chromatographic separation of ions can separate anions.

In various embodiments of the second aspect, the first ion exchange connector further can include one or more first reinforced ion exchange membranes, the first ion exchange membranes and the first reinforced ion exchange membranes can be stacked together. In particular embodiments, the first reinforced ion exchange membranes can include an ion exchange material bound to a polymer mesh.

In various embodiments of the second aspect, the trap chamber can be packed with a cation exchange resin material or an anion exchange resin material or a mixture of anion and cation exchange resin materials.

### BRIEF DESCRIPTION OF THE DRAWINGS

FIG. 1 illustrates an exemplary ion chromatography system, in accordance with various embodiments.

FIG. 2 illustrates an exemplary ion chromatography system with an integrated eluent generator and trap column, in accordance with various embodiments.

FIGS. 3A, 3B, and 3C illustrate exemplary integrated eluent generator and trap columns, in accordance with various embodiments.

FIG. 4 is a flow diagram illustrating analyzing a sample using an ion chromatography system with an integrated eluent generator and trap column, in accordance with various embodiments.

FIGS. 5A, 5B, 5C, and 5D are chromatographic traces using high purity water to supply an ion chromatography system.

FIGS. 6A, 6B, 6C, and 6D are chromatographic traces using 0.8 μM NaNO₃ to supply an ion chromatography system.

FIGS. 7A and 7B are chromatographic traces using high purity water to supply an ion chromatography system.

FIGS. 8A and 8B are chromatographic traces using 0.8 μM NaNO₃ to supply an ion chromatography system.

FIGS. 9A and 9B are chromatographic traces using high purity water to supply an ion chromatography system.

### DETAILED DESCRIPTION

Embodiments of integrated eluent generator and continuously regenerated trap column cartridge are described herein.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless described otherwise, all technical and scientific terms used herein have a meaning as is commonly understood by one of ordinary skill in the art to which the various embodiments described herein belongs.

It will be appreciated that there is an implied “about” prior to the temperatures, concentrations, times, pressures, flow rates, cross-sectional areas, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

As used herein, “a” or “an” also may refer to “at least one” or “one or more.” Also, the use of “or” is inclusive, such that the phrase “A or B” is true when “A” is true, “B” is true, or both “A” and “B” are true. Further, unless otherwise required by context, singular terms shall include pluralities and plural terms shall include the singular.

A “system” sets forth a set of components, real or abstract, comprising a whole where each component interacts with or is related to at least one other component within the whole.

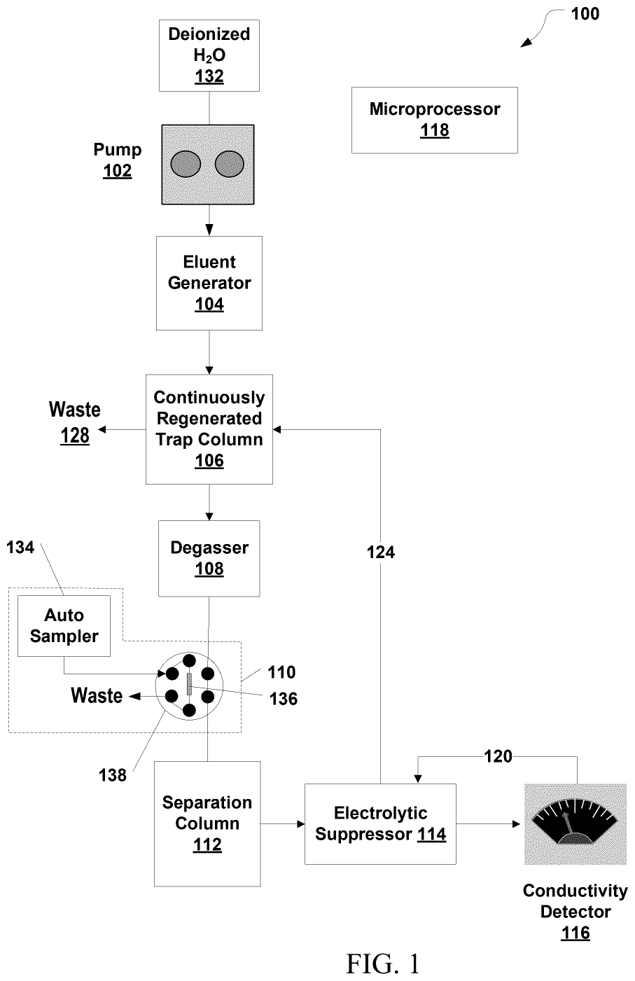

FIG. 1 illustrates an embodiment of a chromatography system 100. Chromatography system 100 may include a pump 102, an electrolytic eluent generator 104, a continuously regenerated trap column 106, a degasser 108, a sample injector 110, a chromatographic separation device 112, an electrolytic suppressor 114, a detector 116, and a microprocessor 118. Chromatographic separation device 112 may be in the form of a capillary column or an analytical column. Line 120 may be used to transfer the liquid from an output of detector 116 to an inlet of the electrolytic suppressor 114. Line 124 may be used to transfer liquid from an outlet of the regenerant channel of the electrolytic suppressor 114 to an inlet of the continuously regenerated trap column 106. Recycle line 126 can be used to transfer liquid from an outlet of the continuously regenerated trap column 106 to waste 128.

Pump 102 can be configured to pump a liquid from a liquid source 132, such as deionized water, and be fluidically connected to electrolytic eluent generator 104. Pump 102 can be configured to transport the liquid at a pressure ranging from about 20 PSI to about 15,000 PSI. Under certain circumstances, pressures greater than 15,000 PSI may also be implemented. It should be noted that the pressures denoted herein are listed relative to an ambient pressure (13.7 PSI to 15.2 PSI). Pump 102 may be in the form of a high-pressure liquid chromatography (HPLC) pump. In addition, pump 102 can also be configured so that the liquid only touches an inert portion of pump 102 so that a significant amount of impurities does not leach out. In this context, significant means an amount of impurities that would interfere with the intended measurement. For example, the inert portion can be made of inert polymers, such as polyether ether ketone (PEEK) or at least coated with a PEEK lining, which does not leach out a significant amount of ions or other contaminants when exposed to a liquid.

An eluent is a liquid that contains an acid, base, salt, or mixture thereof and can be used to elute an analyte through a chromatography column. In addition, an eluent can include a mixture of a liquid and a water miscible organic solvent, where the liquid may include an acid, base, salt, or combination thereof. Electrolytic eluent generator 104 is configured to generate a generant. A generant refers to a particular species of acid, base, or salt that can be added to the eluent. In an embodiment, the generant may be a base such as cation hydroxide or the generant may be an acid such as carbonic acid, phosphoric acid, acetic acid, methanesulfonic acid, or a combination thereof.

Referring to FIG. 1, eluent generator 104 can be configured to receive the liquid from pump 102 and then add a generant to the liquid. The liquid containing the generant can be outputted from eluent generator 104 to an inlet of continuously regenerated trap column 106.

Continuously regenerated trap column 106 is configured to remove cationic or anionic contaminants from the eluent. Continuously regenerated trap column 106 can include an ion exchange bed with an electrode at the eluent outlet. An ion exchange membrane stack can separate the eluent from a second electrode and contaminant ions can be swept through the ion exchange membrane stack towards the second electrode. The ion exchange membrane stack can include one or more ion exchange membranes. In various embodiments, anion removal can utilize an anion exchange bed with a cathode at the eluent outlet separated from an anode by an anion exchange membrane. Alternatively, cation removal can utilize a cation exchange bed with an anode at the eluent outlet separated from a cathode by a cation exchange membrane.

Degasser 108 may be used to remove residual gas. In an embodiment, a residual gas may be electrolytically generated such as hydrogen or oxygen. Degasser 108 may include a tubing section that is gas permeable and liquid impermeable such as, for example, a polymeric tubing. The flowing liquid can be outputted from degasser 108 to sample injector 110 with a substantial portion of the gas removed.

Sample Injector 110 can be used to inject a bolus of a liquid sample into an eluent stream. The liquid sample may include a plurality of chemical constituents (i.e., matrix components) and one or more analytes of interest. The sample injector 110 can include an auto sampler 134, sample loop 136, and a multiport valve 138. The auto sampler 134 can draw a sample from a sample container. The multiport valve 138 can be in a first position to allow the sample to fill the sample loop 136. After the sample loop 136 is filled to the desired level, the multiport valve can switch to a second position and the eluent stream can drive the sample onto the chromatographic separation device 112.

Chromatographic separation device 112 can be used to separate various matrix components present in the liquid sample from the analyte(s) of interest and separate the analytes of interest from each other. Typically, chromatographic separation device 112 may be in the form of a hollow cylinder that contains a packed stationary phase. As the liquid sample flows through chromatographic separation device 112, the matrix components and target analytes can have a range of retention times for eluting off of chromatographic separation device 112. Depending on the characteristics of the target analytes and matrix components, they can have different affinities to the stationary phase in chromatographic separation device 112. An output of chromatographic separation device 112 can be fluidically connected to electrolytic suppressor 114.

Suppressor 114 can be used to reduce eluent conductivity background and enhance analyte response through efficient exchange of eluent counterions for regenerant ions. One type of suppressor is an electrolytic suppressor 114 can include an anode chamber, a cathode chamber, and an eluent suppression bed chamber separated by ion exchange membranes. The anode chamber and/or cathode chamber can produce regenerate ions or transport supplied regenerant ions. The eluent suppression bed chamber can include a flow path for the eluent separated from the regenerant by an ion exchange barrier and eluent counterions can be exchanged with regenerate ions across the ion exchange barrier. An output of electrolytic suppressor 114 can be fluidically connected to detector 116 to measure the presence of the separated chemical constituents of the liquid sample. The suppressor 114 can also be of the chemical kind that requires a chemical regenerant for operation. Any suppressor in the prior art is suited for the present application with multiple channels as configured.

Detector 116 may be in the form of ultraviolet-visible spectrometer, a fluorescence spectrometer, a refractive index detector, a radio flow detector, a chiral detector, an electrochemical detector, a conductivity detector, mass spectrometer, or a combination thereof. The detector 116 is preferably a non-destructive detector such as a conductivity detector that substantially preserves the eluent stream from the suppressor eluent output.

An electronic circuit may include microprocessor 118, a timer, and a memory portion. In addition, the electronic circuit may include a power supply that are configured to apply a controlling signal, respectively. Microprocessor 118 can be used to control the operation of chromatography system 100. Microprocessor 118 may either be integrated into chromatography system 100 or be part of a personal computer that communicates with chromatography system 100. Microprocessor 118 may be configured to communicate with and control one or more components of chromatography system such as pump 102, pump 130, eluent generator 104, sample injector 110, and detector 116. The memory portion may be used to store instructions to set the magnitude and timing of the current waveform with respect to the switching of sample injector 110 that injects the sample.

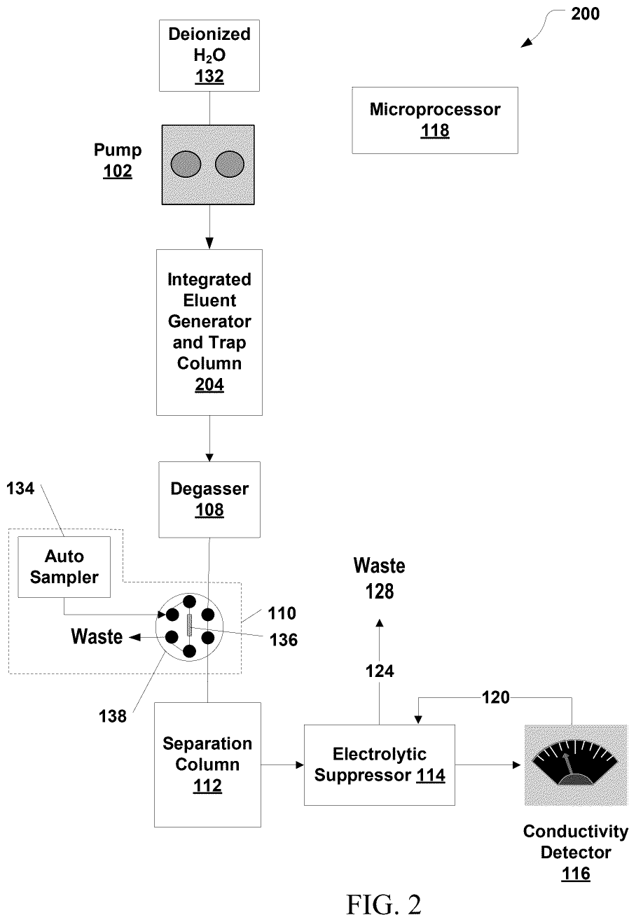

FIG. 2 illustrates an embodiment of a chromatography system 200. Chromatography system 200 is similar to chromatography system 100, except that integrated eluent generator and trap column 204 replaces the functionality of eluent generator 104 and continuously regenerated trap column 106. As integrated eluent generator and trap column 204 doesn't need to the regenerant flow, line 124 may be used to transfer liquid from an outlet of the regenerant channel of the electrolytic suppressor 114 to waste 128.

Combining the eluent generator and trap column into a single device simplifies the RFIC system and increases ease of use. The integrated device also reduces the number of connections, reducing the opportunity for leaks. Additionally, the integrated device utilizes a membrane type design for the trap column allowing higher current and better performance.

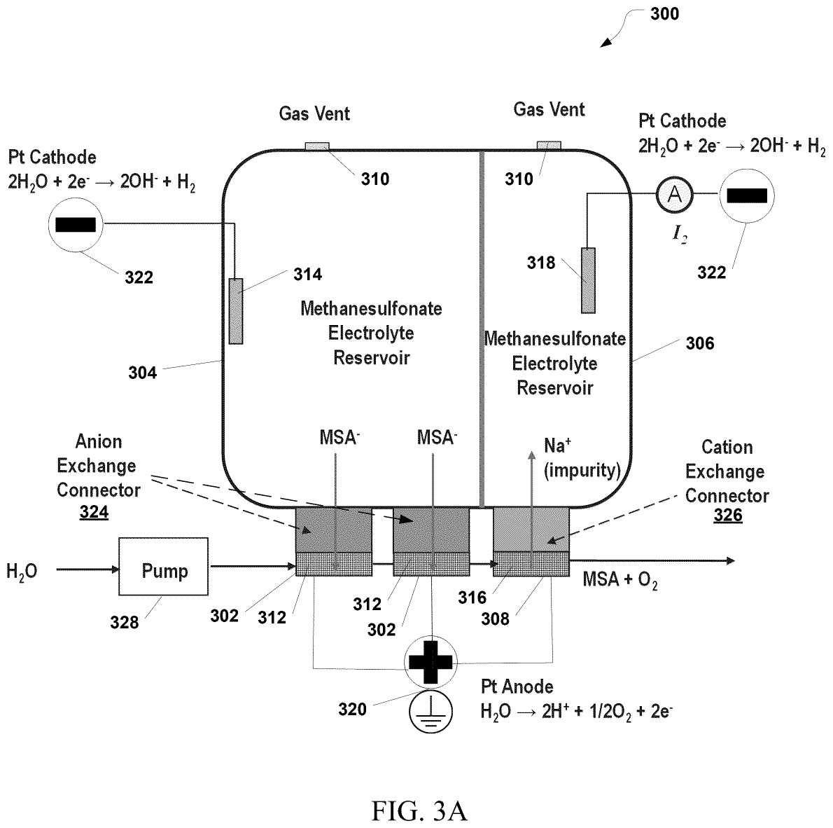

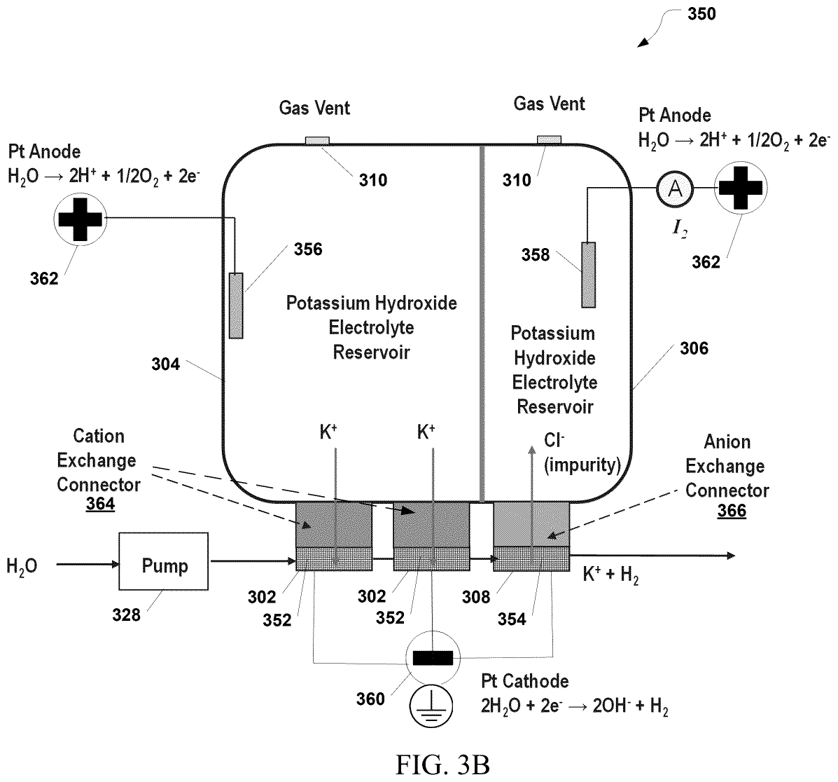

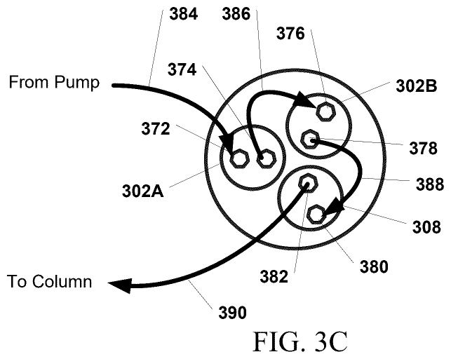

FIG. 3A schematically illustrates the operation principle of an integrated eluent generator and trap column 300, such as integrated eluent generator and trap column 204. The integrated eluent generator and trap column 300 can include one or more eluent generation chambers 302 and a first electrolyte reservoir 304. Additionally, the integrated eluent generator and trap column 300 can include a trap chamber 308 and a second electrolyte reservoir 306. In various embodiments, the generation chamber 302 and the trap chamber 308 can operate pressures greater than about 2,000 psi, such as at least about 5,000 psi, even at least about 10,000 psi, but not greater than about 30,000 psi, such as not greater than about 15,000 psi. The first and second electrolyte reservoirs can be maintained at close to atmospheric pressure with the gas vents 310.

The eluent generation chambers 302 can contain an anode 312 and the trap chamber 308 can contain an anode 316. In various embodiments, anode 312 and 316 can be porous anodes, such as porous platinum (Pt) anodes. The first electrolyte reservoir 304 can contain a cathode 314 and a first electrolyte solution. Similarly, the second electrolyte reservoir 306 can contain a cathode 318 and a second electrolyte solution. In various embodiments, the concentration of the first electrolyte solution can be greater than the concentration of the second electrolyte solution. In various embodiments, the composition of the first electrolyte solution and the second electrolyte solution can be different.

In various embodiments, cathode 314 and cathode 318 can be platinum cathodes. Anodes 312 and 316 can be connected to a common ground 320 while cathodes 314 and 318 can be electrically coupled to a current sources 322. In some embodiments, cathodes 314 and 318 can be connected to the different current sources 322 allowing for different voltage and current settings on cathodes 314 and 318. In alternate embodiments, the system can be simplified by using a common current source 322 for cathodes 314 and 318. In this arrangement, the integrated eluent generator and trap column 300 can produce an acidic eluent, such as methanesulfonic acid, carbonic acid, phosphoric acid, or acetic acid, and remove contaminate cations from the eluent.

The eluent generation chambers 302 can be connected to the first electrolyte reservoir 304 by means of anion exchange connectors 324 which can permit the passage of anions (negatively charged ions) while substantially preventing the passage of cations (positively charged ions) from the electrolyte reservoir 304 into the generation chamber 302. Trap chamber 308 can be connected to the second electrolyte reservoir 306 by means of cation exchange connectors 326 which can permit the passage of positively charged ions (contaminate cations) while substantially preventing the passage of anions from the trap chamber 308 to the electrolyte reservoir 306. Additionally, anion exchange connectors 324 can substantially prevent bulk liquid flow between the first electrolyte chamber 304 and eluent generation chambers 302 and cation exchange connector 326 can substantially prevent bulk liquid flow between the second electrolyte chamber 306 and trap chamber 308.

In various embodiments, the first electrolyte solution and/or the second electrolyte solution can further include a surfactant. The surfactant in the first electrolyte solution can be a cationic surfactant such that the anion exchange connectors 324 can exclude the surfactant from passing to the eluent generation chamber 302. The surfactant in the second electrolyte solution can be an anionic surfactant such that the cation exchange connector 326 can exclude the surfactant from passing to the trap chamber 308.

In various embodiments, the surfactants can be a non-ionic surfactant.

In various embodiments, the surfactant can be an acid stable surfactant.

Anion exchange connectors 324 and cation exchange connector 326 can serve the critical role of a high-pressure physical barrier between the low-pressure electrolyte reservoirs 304 and 306 and the high-pressure eluent generation chambers 302 and trap chamber 308.

The anion exchange connector 324 can include one or more anion exchange membranes. In various embodiments, the anion exchange connector 324 can further include one or more reinforced anion exchange membranes. The anion exchange membranes and the reinforced anion exchange membranes can be stacked together, such as in alternating layers.

Similarly, the cation exchange connector 326 can include one or more cation exchange membranes. In various embodiments, the cation exchange connector 326 can further include one or more reinforced cation exchange membranes. The cation exchange membranes and the reinforced cation exchange membranes can be stacked together, such as in alternating layers.

In various embodiments, the reinforced anion exchange membranes can include anion exchange material bound to a polymer mesh and the reinforced cation exchange membranes can include cation exchange material bound to a polymer mesh.

In various embodiments, the trap chamber 308 can be packed with cation exchange resin material, such as a packed bed of cation exchange particles or a liquid permeable cation exchange monolith. In various embodiments, the trap chamber 308 can be packed with a combination of cation exchange resin material and anion exchange resin material. To generate a methanesulfonic acid eluent, deionized water can be pumped, by pump 328, through the eluent generation chamber 302 and a DC current can be applied between the anode 312 and cathode 314. Under the applied field, the electrolysis of water can occur at both the anode 312 and cathode 314 of the device 300. Water can be oxidized to form H+ ions and oxygen gas at the anode 312 in the eluent generation chamber 302: H₂O→2H⁺+½ O₂↑+2e⁻. Water can be reduced to form OH— ions and hydrogen gas at the cathode 314 in the electrolyte reservoir 304: 2H₂O+2e⁻→2 OH⁻+H₂↑. As OH⁻ ions, generated at the cathode 314, displaces methanesulfonate ions in the electrolyte reservoir 304, the displaced ions can migrate across the anion exchange connector 324 into the eluent generation chamber 302. These methanesulfonate ions can combine with hydronium ions generated at the anode 312 to produce the methanesulfonic acid solution, which can be used as the eluent for cation exchange chromatography. The concentration of generated methanesulfonic acid can be determined by the current applied to the cathode 314 and the carrier water flow rate through the generation chamber 302.

The methanesulfonic acid eluent can move to the trap chamber 308 and a DC voltage or current can be applied between the anode 316 and cathode 318. Under the applied field, the electrolysis of water can occur at both the anode 316 and cathode 318 of the device 300. Water can be oxidized to form H⁺ ions and oxygen gas at the anode 316 in the trap chamber 308: H₂O→2H⁺+½ O₂↑+2e⁻. Water can be reduced to form OH— ions and hydrogen gas at the cathode 318 in the electrolyte reservoir 306: 2H₂O+2e⁻→2 OH⁻+H₂↑. As H+ ions, generated at the anode 316, displaces contaminant cations in the trap chamber 308, the displaced contaminant cations can migrate across the cation exchange connector 326 into the electrolyte reservoir 306, thereby eliminating contaminant cations from the eluent.

FIG. 3B schematically illustrates the operation principle of an integrated eluent generator and trap column 350, such as integrated eluent generator and trap column 204. Similarly to integrated eluent generator and trap column 300, the integrated eluent generator and trap column 350 can include one or more eluent generation chambers 302 and a first electrolyte reservoir 304. Additionally, the integrated eluent generator and trap column 350 can include a trap chamber 308 and a second electrolyte reservoir 306. In various embodiments, the generation chamber 302 and the trap chamber 308 can operate pressures greater than about 2,000 psi, such as at least about 5,000 psi, even at least about 10,000 psi, but not greater than about 30,000 psi, such as not greater than about 15,000 psi. The first and second electrolyte reservoirs can be maintained at close to atmospheric pressure with the gas vents 310.

The eluent generation chambers 302 can contain a cathode 352 and the trap chamber 308 can contain a cathode 354. In various embodiments, anode 352 and 354 can be porous cathodes, such as porous platinum (Pt) cathodes. The first electrolyte reservoir 304 can contain an anode 356 and a first electrolyte solution. Similarly, the second electrolyte reservoir 306 can contain an anode 358 and a second electrolyte solution. In various embodiments, the concentration of the first electrolyte solution can be greater than the concentration of the second electrolyte solution. In various embodiments, the composition of the first electrolyte solution and the second electrolyte solution can be different.

In various embodiments, anode 356 and anode 358 can be platinum anodes. Cathodes 352 and 354 can be connected to a common ground 360 while anodes 356 and 358 can be electrically coupled to current sources 362. In some embodiments, anodes 356 and 358 can be connected to the different current sources 362 allowing for different voltage and current settings on anodes 356 and 358. In alternate embodiments, the system can be simplified by using a common current source 362 for anodes 356 and 358. In this arrangement, the integrated eluent generator and trap column 350 can produce a basic eluent, such as potassium hydroxide, sodium hydroxide, or the like, and remove contaminate anions from the eluent.

The eluent generation chambers 302 can be connected to the first electrolyte reservoir 304 by means of cation exchange connectors 364 which can permit the passage of while substantially preventing the passage of anions from the electrolyte reservoir 304 into the generation chamber 302. Trap chamber 308 can be connected to the second electrolyte reservoir 306 by means of anion exchange connectors 366 which can permit the passage of contaminant anions while substantially preventing the passage of cations from the trap chamber 308 to the electrolyte reservoir 306. Additionally, cation exchange connectors 364 can substantially prevent bulk liquid flow between the first electrolyte chamber 304 and eluent generation chambers 302 and cation exchange connector 366 can substantially prevent bulk liquid flow between the second electrolyte chamber 306 and trap chamber 308.

In various embodiments, the first electrolyte solution and/or the second electrolyte solution can further include a surfactant. The surfactant in the first electrolyte solution can be an anionic surfactant such that cation exchange connectors 364 can exclude the surfactant from passing to the eluent generation chamber 302. The surfactant in the second electrolyte solution can be a cationic surfactant such that the anion exchange connector 366 can exclude the surfactant from passing to the trap chamber 308.

In various embodiments, the surfactants can be a non-ionic surfactant.

In various embodiments, the surfactant can be a caustic stable surfactant.

Cation exchange connectors 364 and anion exchange connector 366 can serve the critical role of a high-pressure physical barrier between the low-pressure electrolyte reservoirs 304 and 306 and the high-pressure eluent generation chambers 302 and trap chamber 308.

The anion exchange connector 366 can include one or more anion exchange membranes. In various embodiments, the anion exchange connector 366 can further include one or more reinforced anion exchange membranes. The anion exchange membranes and the reinforced anion exchange membranes can be stacked together, such as in alternating layers.

Similarly, the cation exchange connector 364 can include one or more cation exchange membranes. In various embodiments, the cation exchange connector 364 can further include one or more reinforced cation exchange membranes. The cation exchange membranes and the reinforced cation exchange membranes can be stacked together, such as in alternating layers.

In various embodiments, the reinforced anion exchange membranes can include anion exchange material bound to a polymer mesh and the reinforced cation exchange membranes can include cation exchange material bound to a polymer mesh

In various embodiments, the trap chamber 308 can be packed with anion exchange resin material, such as a packed bed of anion exchange particles or a liquid permeable anion exchange monolith. In various embodiments, the trap chamber 308 can be packed with a combination of cation exchange resin material and anion exchange resin material.

To generate a potassium hydroxide eluent, deionized water can be pumped, by pump 328, through the eluent generation chamber 302 and a DC current can be applied between the cathode 352 and anode 356. Under the applied field, the electrolysis of water can occur at both the cathode 352 and anode 356 of the device 350. Water can be oxidized to form H⁺ ions and oxygen gas at the anode 356 in the electrolyte reservoir 304: H₂O→2H⁺+½ O₂↑+2e⁻. Water can be reduced to form OH ions and hydrogen gas at the cathode 352 in the eluent generation chamber 302: 2H₂O+2e⁻→2 OH⁻+H₂↑. As hydronium ions, generated at the anode 356, displaces potassium ions in the electrolyte reservoir 304, the displaced ions can migrate across the cation exchange connector 364 into the eluent generation chamber 302. These potassium ions can combine with OH ions generated at the cathode 352 to produce the potassium hydroxide solution, which can be used as the eluent for anion exchange chromatography. The concentration of generated potassium hydroxide can be determined by the current applied to the anode 356 and the carrier water flow rate through the generation chamber 302.

The potassium hydroxide eluent can move to the trap chamber 308 and a DC voltage or current can be applied between the cathode 354 and anode 358. Under the applied field, the electrolysis of water can occur at both the cathode 354 and anode 358 of the device 350. Water can be oxidized to form H⁺ ions and oxygen gas at the anode 358 in the electrolyte reservoir 306: H₂O→2H⁺+½ O₂↑+2e⁻. Water can be reduced to form OH— ions and hydrogen gas at the cathode 354 in the trap chamber 308: 2H₂O+2e⁻→2 OH⁻+H₂↑. As OH⁻ ions, generated at the cathode 354, displace contaminant anions in the trap chamber 308, the displaced contaminant anions can migrate across the anion exchange connector 366 into the electrolyte reservoir 306, thereby eliminating contaminant anions from the eluent.

FIG. 3C illustrated an exemplary arrangement of the eluent generation chambers 302A and 302B and the trap chamber 308 that is suitable for either integrated eluent generator and trap column 300 or 350. Eluent generation chamber 302A includes an inlet 372 and an outlet 374. Eluent generation chamber 302B includes an inlet 376 and an outlet 378. Trap chamber 308 includes an inlet 380 and an outlet 382. Water from the pump 328 can flow through line 384 into the inlet 372 of eluent generation chamber 302A. The fluid can flow through line 386 from the outlet 374 of eluent generation chamber 302B to the inlet 376 of eluent generation chamber 302B. The fluid can then flow through line 388 from outlet 378 of eluent generation chamber 302B to inlet 380 of trap chamber 308. The fluid can then flow through line 390 from the outlet of trap chamber 308 towards the degasser.

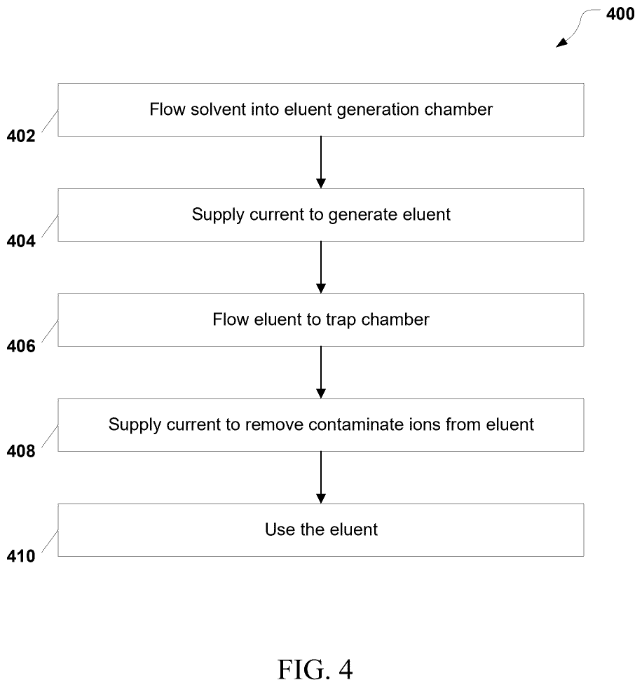

FIG. 4 illustrates a method 400 of preparing an eluent for use in an ion chromatography system. At 402, a solvent is supplied to an eluent generation chamber, such as eluent generation chamber 302 of FIG. 3A or 3B. Generally, the solvent can include deionized water. The eluent generation chamber can be connected to a first electrolyte reservoir by way of a first ion exchange connector. The first electrolyte reservoir can include a first electrolyte solution and a first electrode. The eluent generation chamber can include a second electrode. The first electrode can be connected to a first current supply and the second electrode can be connected to a common ground.

The first ion exchange connector can include one or more first ion exchange membranes. In various embodiments, the first ion exchange connector can further include one or more first reinforced ion exchange membranes. The first ion exchange membranes and the first reinforced ion exchange membranes can be stacked together, such as in alternating layers.

Similarly, the second ion exchange connector can include one or more second ion exchange membranes. In various embodiments, the second ion exchange connector can further include one or more second reinforced ion exchange membranes. The second ion exchange membranes and the second reinforced ion exchange membranes can be stacked together, such as in alternating layers.

In various embodiments, the first and second reinforced ion exchange membranes can include an ion exchange material bound to a polymer mesh.

At 404, a current can be supplied by the first current supply to the first electrode. As the second electrode is connected a common ground, the current can electrolyze the solvent at second electrode and to drive eluent counter ions from the electrolyte reservoir through the first ion exchange connector into the solvent. The electrolyzed solvent and the eluent counter ions can combine in the eluent generation chamber to create the eluent.

At 406, the eluent can flow from the eluent generation chamber to the trap chamber. The trap chamber can be connected to a second electrolyte reservoir by way of a second ion exchange connector. The second electrolyte reservoir chamber can include a second electrolyte solution and a third electrode. The trap chamber can include a fourth electrode. The third electrode connected to a second current supply and the fourth electrode connected to the common ground.

At 408, a current can be supplied by the second current supply to the third electrode. As the fourth electrode is connected a common ground, the current can drive contaminant ions from the trap chamber into the second electrolyte reservoir through the second ion exchange connector

At 410, the eluent can be used to chromatographically separate ions within a sample.

In various embodiments, the chromatographic separation can utilize an acidic eluent to separate cations. The first ion exchange connector can include one or more anion exchange membranes and the second ion exchange connector can include one or more cation exchange membranes. Additionally, the first and third electrodes can be cathodes and the second and fourth electrodes can be anodes. Further, the first and second electrolyte solutions can contain counter ions with a negative charge and the contaminant ions can be cations.

In various embodiments, the chromatographic separation can utilize a basic eluent to separate anions. The first ion exchange connector can include one or more cation exchange membranes and the second ion exchange connector can include one or more anion exchange membranes. Additionally, the first and third electrodes can be anodes and the second and fourth electrodes can be cathodes. Further, the first and second electrolyte solutions can contain counter ions with a positive charge and the contaminant ions can be anions.

### Example 1

A sample of six common cations (1—lithium, 2—sodium, 3—ammonium, 4—potassium, 5—magnesium, and 6—calcium) is separated on an IC system using separate electrolytic eluent generator and continuously regenerated trap column and an IC system where the separate electrolytic eluent generator and continuously regenerated trap column are replaced with an integrated eluent generator and trap column. Eluent conditions are 6 mM methanesulfonic acid (MSA) from 0-1 min; 6-60 mM MSA 1-30 min; 60 mM MSA 30-35 min; and 6 mM MSA 35-50 min. The flow rate is 0.36 mL/min and the injection volume is 10 μL. Separation is performed with Dionex IonPac CS16 3-mm separator.

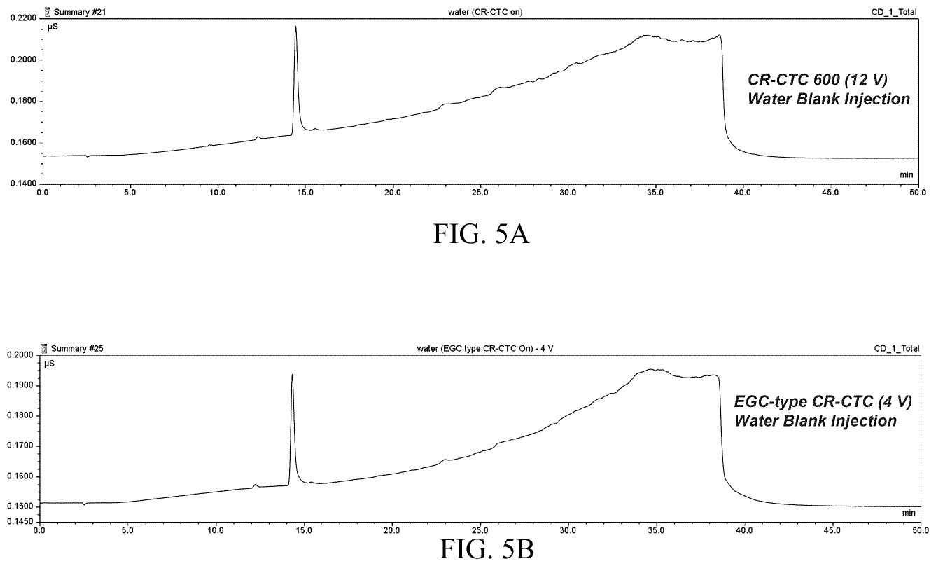

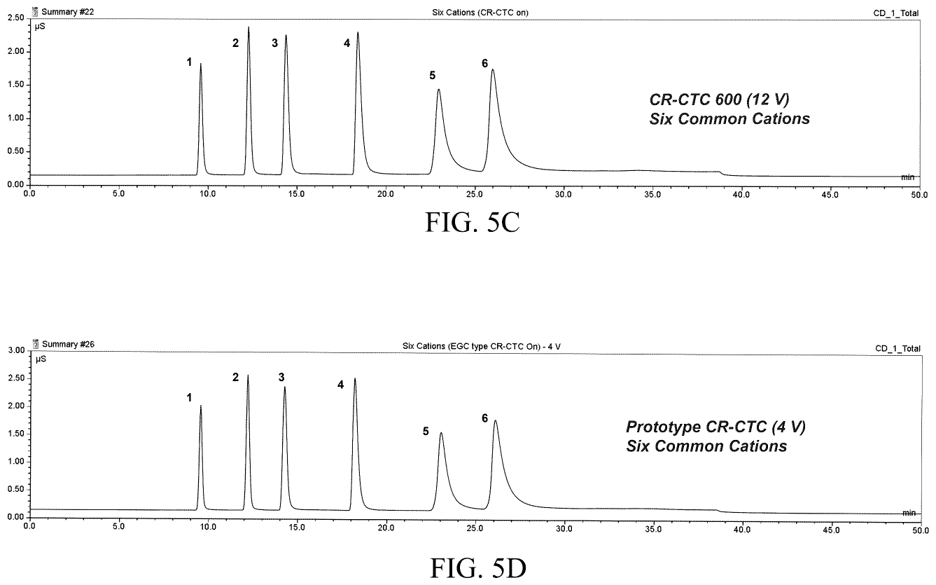

FIGS. 5A, 5B, 5C, and 5D show results using deionized water with a conductivity of 18 MΩ·cm to feed into the eluent generator. FIG. 5A shows a water blank injection using the separate electrolytic eluent generator and continuously regenerated trap column. FIG. 5B shows a water blank injection using the integrated eluent generator and trap column. FIG. 5C shows the separation of the six common cations sample using the separate electrolytic eluent generator and continuously regenerated trap column. FIG. 5D shows the separation of the six common cations sample using the integrated eluent generator and trap column. For FIGS. 5C and 5D, peaks are labeled as 1—lithium, 2—sodium, 3—ammonium, 4—potassium, 5—magnesium, and 6—calcium.

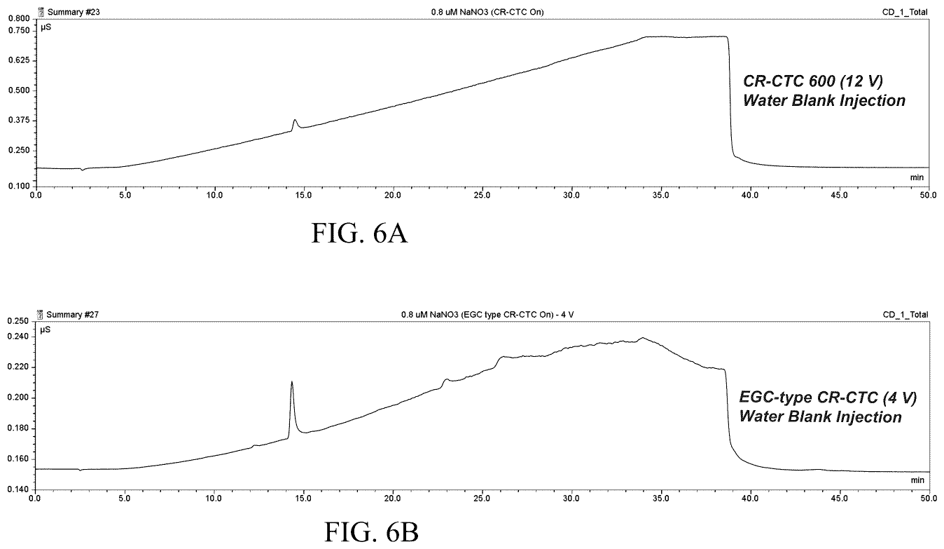

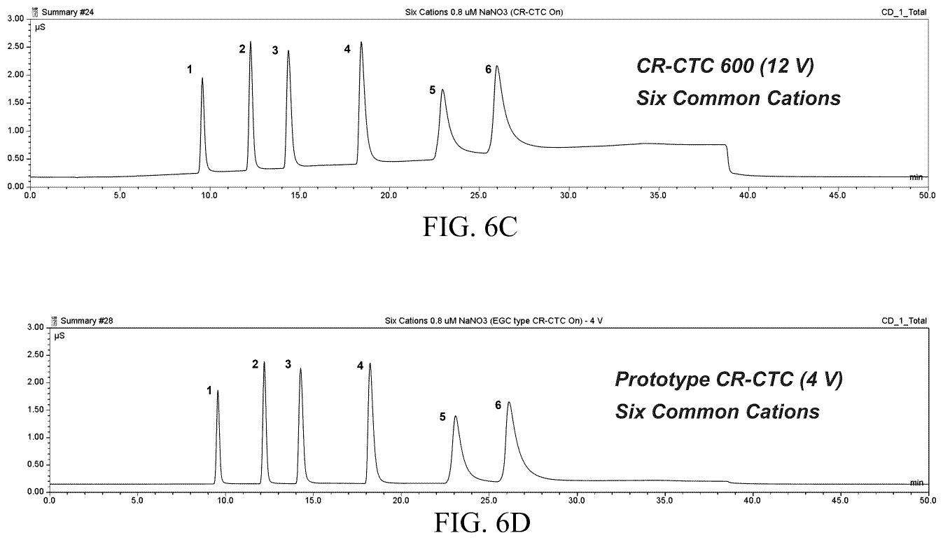

FIGS. 6A, 6B, 6C, and 6D show results using 0.8 μM sodium nitrate to simulate water with a conductivity of 10 MΩ·cm to feed into the eluent generator. FIG. 6A shows a water blank injection using the separate electrolytic eluent generator and continuously regenerated trap column. FIG. 6B shows a water blank injection using the integrated eluent generator and trap column. FIG. 6C shows the separation of the six common cations sample using the separate electrolytic eluent generator and continuously regenerated trap column. FIG. 6D shows the separation of the six common cations sample using the integrated eluent generator and trap column. For FIGS. 6C and 6D, peaks are labeled as 1—lithium, 2—sodium, 3—ammonium, 4—potassium, 5—magnesium, and 6—calcium.

It is to be understood that features described with regard to the various embodiments herein may be mixed and matched in any combination without departing from the spirit and scope of the disclosure. Although different selected embodiments have been illustrated and described in detail, it is to be appreciated that they are exemplary, and that a variety of substitutions and alterations are possible without departing from the spirit and scope of the present disclosure.

### Example 2

A steep gradient profile is evaluated on an IC system using separate electrolytic eluent generator and continuously regenerated trap column and an IC system where the separate electrolytic eluent generator and continuously regenerated trap column are replaced with an integrated eluent generator and trap column. Eluent conditions are 5 mM potassium hydroxide (KOH) from 0-1 min; 5-75 mM KOH 1-12 min; 75 mM KOH 12-15 min, and 5 mM 60 mM KOH 15-35 min. The flow rate is 0.25 mL/min and the injection volume is 10 μL. Separation is performed with Dionex IonPac AS19 2-mm separator.

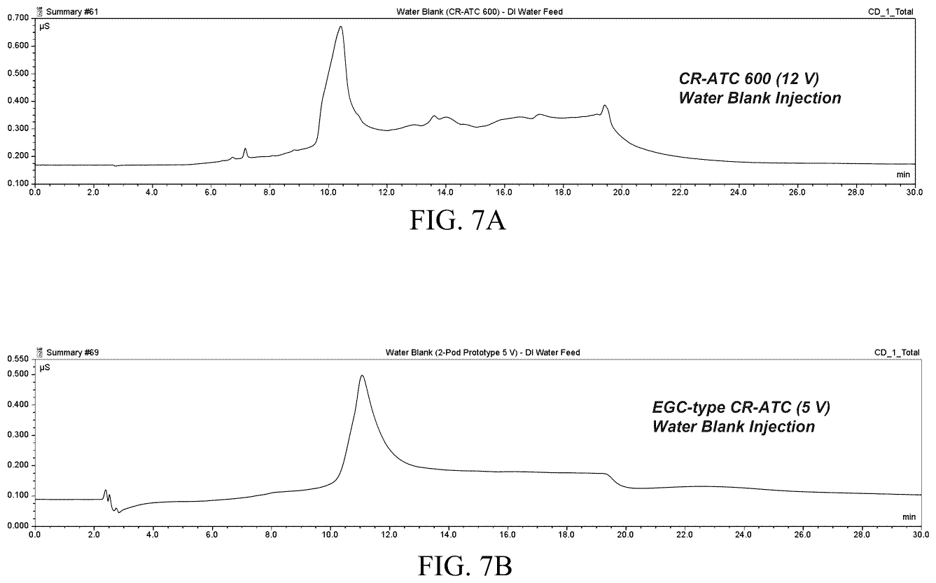

FIGS. 7A and 7B show results using deionized water with a conductivity of 18 MΩ·cm to feed into the eluent generator. FIG. 7A shows a water blank injection using the separate electrolytic eluent generator and continuously regenerated trap column. FIG. 7B shows a water blank injection using the integrated eluent generator and trap column.

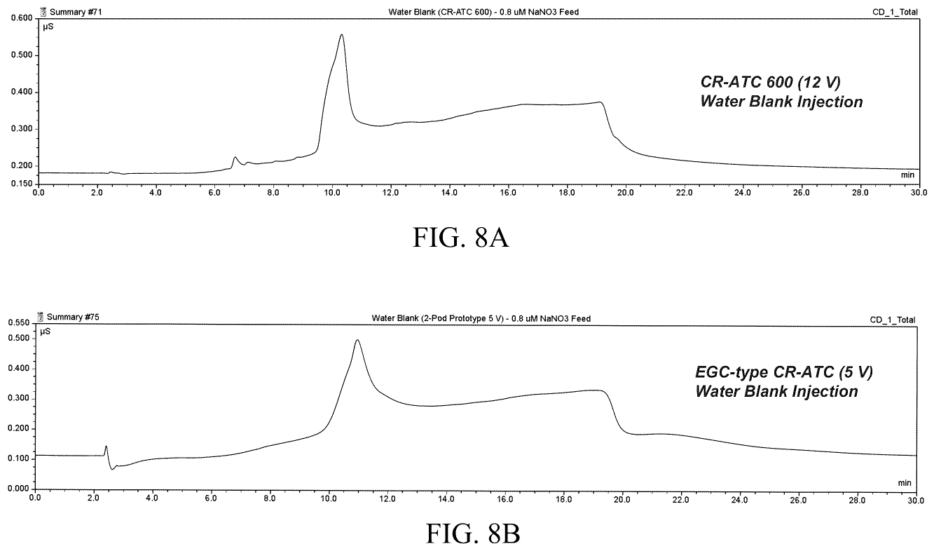

FIGS. 8A and 8B show results using 0.8 μM sodium nitrate to simulate water with a conductivity of 10 MΩ·cm to feed into the eluent generator. FIG. 8A shows a water blank injection using the separate electrolytic eluent generator and continuously regenerated trap column. FIG. 8B shows a water blank injection using the integrated eluent generator and trap column.

### Example 3

A sample of seven common anions (fluoride, chlorides, nitrite, bromide, nitrate, sulfate and phosphate) is separated on an IC system using separate electrolytic eluent generator and continuously regenerated trap column and an IC system where the separate electrolytic eluent generator and continuously regenerated trap column are replaced with an integrated eluent generator and trap column. Eluent conditions are 11 mM potassium hydroxide (KOH) from 0-10 min; 11-42 mM KOH 10-25 min; 11 mM KOH 25-35 min. The flow rate is 0.25 mL/min and the injection volume is 10 μL. Separation is performed with Dionex IonPac AS19 2-mm separator.

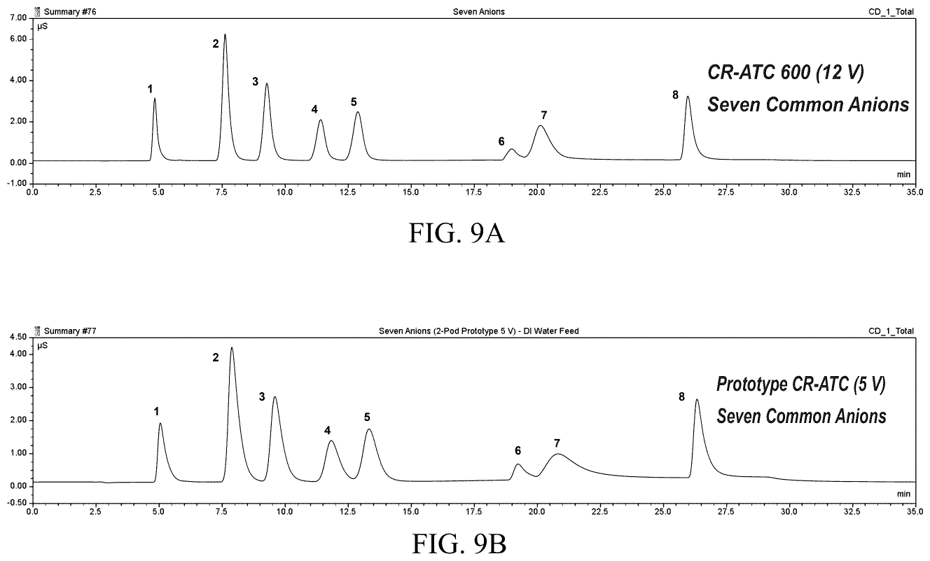

FIG. 9A shows the separation of the seven common anions sample using the separate electrolytic eluent generator and continuously regenerated trap column. FIG. 9B shows the separation of the seven common anions sample using the integrated eluent generator and trap column. For FIGS. 9A and 9B, peaks are labeled as 1-fluoride, 2-chlorides, 3-nitrite, 4-bromide, 5-nitrate, 6-carbonate, 7-sulfate and 8-phosphate.

1. An electrolytic device for an ion chromatography system, the electrolytic device comprising:
a first electrolyte reservoir including a first electrolyte solution and a first electrode;
an eluent generation chamber including a second electrode;
a first ion exchange connector coupling the eluent generation chamber to the first electrolyte reservoir, the first ion exchange connector including one or more first ion exchange membranes allowing passage of counter ions with a first charge but excluding ions with an opposite charge;
a second electrolyte reservoir including a second electrolyte solution and a third electrode;
a trap chamber including a fourth electrode; and
a second ion exchange connector coupling the trap chamber to the second electrolyte reservoir, the second ion exchange connector including one or more second ion exchange membranes, the second ion exchange membranes excluding ions of the first charge but allowing passage of contaminant ions of the opposite charge;
wherein the first and third electrodes are connected to a current source and the second and fourth electrodes are connected to a common ground;
wherein the device is configured to generate an eluent for chromatographic separation of ions of a second charge and to remove contaminant ions of the second charge from the eluent.

2. The electrolytic device of claim 1, wherein the second and fourth electrodes are porous electrodes.

3. The electrolytic device of claim 2, wherein the first, second, third, and fourth electrodes are platinum electrodes.

4. The electrolytic device of claim 1, wherein the concentration of the first electrolyte solution is different than the concentration of the second electrolyte solution.

5. The electrolytic device of claim 1, wherein the first ion exchange membranes are anion exchange membranes, the second ion exchange membranes are cation exchange membranes, the first and third electrodes are cathodes, the second and fourth electrodes are anodes, the electrolyte contains counter ions with a negative charge, the contaminant ions are cations, and the chromatographic separation of ions separates cations.

6. (canceled)

7. (canceled)

8. The electrolytic device of claim 5, wherein the second electrolyte solution includes an anionic surfactant.

9. The electrolytic device of claim 5, wherein the first electrolyte solution includes a cationic surfactant.

10. The electrolytic device of claim 1, wherein the first ion exchange membranes are cation exchange membranes, the second ion exchange membranes are anion exchange membranes, the first and third electrodes are anodes, the second and fourth electrodes are cathodes, the electrolyte contains counter ions with a positive charge, the contaminant ions are anions, and the chromatographic separation of ions separates anions.

11. (canceled)

12. (canceled)

13. The electrolytic device of claim 10, wherein the second electrolyte solution includes a cationic surfactant.

14. The electrolytic device of claim 10, wherein the first electrolyte solution includes an anionic surfactant.

15. The electrolytic device of claim 1, wherein the first ion exchange connector further includes one or more first reinforced ion exchange membranes, the first ion exchange membranes and the first reinforced ion exchange membranes stacked together.

16. (canceled)

17. The electrolytic device of claim 1, wherein the first electrolyte solution or the second electrolyte solution include a non-ionic surfactant.

18. The electrolytic device of claim 1, wherein the trap chamber is packed with a cation exchange resin material or an anion exchange resin material or a mixture of anion and cation exchange resin materials.

19. A method of performing an ion chromatography separation, comprising:
flowing a solvent into an eluent generation chamber, the eluent generation chamber connected to a first electrolyte reservoir with a first ion exchange connector, the first electrolyte reservoir including a first electrolyte solution and a first electrode, the eluent generation chamber including a second electrode, the first electrode connected to a first current supply and the second electrode connected to a common ground;
supplying a current from the first current supply to electrolyze the solvent at the second electrode and to drive eluent counter ions from the electrolyte reservoir through the first ion exchange connector into the solvent to generate an eluent;
flowing the eluent into a trap chamber, the trap chamber connected to a second electrolyte reservoir with a second ion exchange connector, the second electrolyte reservoir chamber including a second electrolyte solution and a third electrode, the trap chamber including a fourth electrode, the third electrode connected to a second current supply and the fourth electrode connected to the common ground;
supplying a current from the second current supply to drive contaminant ions from the trap chamber through the second ion exchange connector into the second electrolyte reservoir; and
using the eluent to chromatographical separate ions within a sample.

20. (canceled)

21. (canceled)

22. The method of claim 19, wherein the concentration of the first electrolyte solution is different than the concentration of the second electrolyte solution.

23. The method of claim 19, wherein the first ion exchange connector includes one or more first ion exchange membranes, the second ion exchange connector includes one or more second ion exchange membranes, the first ion exchange membranes are anion exchange membranes, the second ion exchange membranes are cation exchange membranes, the first and third electrodes are cathodes, and the second and fourth electrodes are anodes.

24. (canceled)

25. The method of claim 23, wherein the electrolyte contains counter ions with a negative charge, the contaminant ions are cations, and the chromatographic separation of ions separates cations.

26. The method of claim 19, wherein the first ion exchange connector includes one or more first ion exchange membranes, the second ion exchange connector includes one or more second ion exchange membranes, the first ion exchange membranes are cation exchange membranes, the second ion exchange membranes are anion exchange membranes, the first and third electrodes are anodes, and the second and fourth electrodes are cathodes.

27. (canceled)

28. The method of claim 26, wherein the electrolyte contains counter ions with a positive charge, the contaminant ions are anions, and the chromatographic separation of ions separates anions.

29. The method of claim 19, wherein the first ion exchange connector further includes one or more first reinforced ion exchange membranes, the first ion exchange membranes and the first reinforced ion exchange membranes stacked together.

30. (canceled)

31. The method of claim 19, wherein the trap chamber is packed with a cation exchange resin material or an anion exchange resin material or a mixture of anion and cation exchange resin materials.
